(19) United States
(12) Patent Application Publication
(10) Pub. No.: US 2006/0227481 A1
(43) Pub. Date: Oct. 12, 2006

(54) Power supply for a bus interface

(75) Inventors: Yong-Zhao Huang, Shenzhen (CN); Yun Li, Shenzhen (CN); Yong-Xing You, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/388,258

(22) Filed: Mar. 24, 2006

(30) Foreign Application Priority Data
Apr. 8, 2005 (CN) 200510034112.X

(51) Int. Cl. H02H 5/04

(52) U.S. Cl. 361/104

(57) ABSTRACT

A power supply for a bus interface is provided. The power supply comprises: an input terminal; an output terminal; a fuse providing over-current protection; a diode providing over-voltage protection, a reverse breakdown voltage of the diode not less than a maximal voltage difference of the output terminal and the input terminal, the diode connected to the fuse in series between an input terminal and an output terminal; and a plurality of capacitors filtering noise, one end of each of the capacitors connected to a node between the fuse and an anode of the diode, and another end of each of the capacitors is grounded. The power supply can provide effective over-voltage protection because a reverse breakdown voltage of the diode is not less than a maximal voltage difference of the output terminal and the input terminal. In addition, the power supply has a low cost of manufacture.

### BACKGROUND

1. Field of the Invention

The present invention relates to a power supply for a bus, and particularly to a power supply used for an Institute of Electrical and Electronics Engineers Standard 1394 (IEEE1394) bus.

2. General Background

The Institute of Electrical and Electronics Engineers Computer Society published the IEEE STD 1394-1995 entitled, “IEEE Standard for a High Performance Serial Bus.” This standard and its following supplements define a serial data bus with a cable and backplane environment, non-cyclic topology, scalable data rates starting at 100 Megabits per second, and a cable arbitration system that uses a self-configuring hierarchical request/grant protocol that supports hot plugging and widely varying physical topologies.

FIG. 3 illustrates a typical voltage regulator for regulating the power supply of an IEEE1394 bus. The voltage regulator includes a diode 2, a magnetic bead 3, a fuse 4, and capacitors C1, C2, C3, and C4. An input end 1 is connected to the anode of the diode 2. The cathode of the diode 2 is connected to an output end 5 via the magnetic bead 3 and the fuse 4. Nodes a, b between the cathode of the diode 2 and the magnetic bead 3 are separately grounded via the capacitors C1, C2. A node c between the magnetic bead 3 and the fuse 4 is grounded via the capacitor C3. A node d between the fuse 4 and the output end 5 is grounded via the capacitor C4. The input end 1 is employed to receive a voltage from a power supply. The output end 5 is employed to provide a voltage to the IEEE1394 bus. The reverse breakdown voltage of the diode 2 is 20V. The rated current of the fuse is 2.6 A. The rated voltage of the capacitors C1, C2, C3, and C4 is 25V.

According to the IEEE1394 STD, voltage of equipment connected to the IEEE1394 bus ranges between 8V and 40V, and the current flowing through the equipment must not be more than 1.5 A. However, an operational voltage of the diode 2 may reach 40V due to a transient over loading of voltage and current, that is, the operational voltage of the diode 2 may be over the reverse breakdown voltage of the diode 2. When the operational voltage of the diode 2 is over the reverse breakdown voltage of the diode 2, the diode 2 will break down. Consequently the electronic circuit and equipment are damaged. Thus it can be seen that the diode 2 having a 20V reverse breakdown voltage cannot provide effective over-voltage protection to the circuit and equipment. In addition, the rated current of the fuse 4 is 2.6 A, well over the IEEE1394 standard and does not provide over-current protection to the circuit and equipment when the current through the equipment ranges between 1.5 A and 2.6 A. Operation voltage of the capacitors C1, C2, C3 and C4 may reach 40V, clearly over their rating, thus the capacitors C1, C2, C3 and C4 may break down as well. However, if capacitors having a higher voltage rating are employed, a cost of making the circuit will increase.

What is needed, therefore, is a power supply for interfaces of bus both able to provide an effective over voltage protection and to the circuit and equipment, and have a low cost.

### SUMMARY

A power supply for a bus interface is provided. In a preferred embodiment, the power supply comprises: an input terminal; an output terminal; a fuse providing over-current protection; a diode providing over-voltage protection, a reverse breakdown voltage of the diode being not less than a maximal voltage difference of the output terminal and the input terminal, the diode is connected to the fuse in series between an input terminal and an output terminal; and a plurality of capacitors filtering noise, one end of each of the capacitors connected to a node between the fuse and an anode of the diode, and another end of each of the capacitors grounded.

The capacitors are located between the input terminal and the anode of the diode. Thus the power supply can employ capacitors, which have a low voltage rating. Thereby, cost of the power supply will decrease. In addition, a reverse breakdown voltage of the diode is not less than a maximal voltage difference of the output terminal and the input terminal. Therefore, the power supply can provide effective over-voltage protection.

Other advantages and novel features will become more apparent from the following detailed description of preferred embodiments when taken in conjunction with the accompanying drawings, in which:

### BRIEF DESCRIPTION OF THE DRAWINGS

FIG. 1 is a circuit diagram of a power supply for a bus interface of a preferred embodiment of the present invention;

FIG. 2 is a circuit diagram of a power supply for a bus interface of another preferred embodiment of the present invention; and

FIG. 3 is a circuit diagram of a typical power supply for a bus interface.

### DETAILED DESCRIPTION OF THE EMBODIMENTS

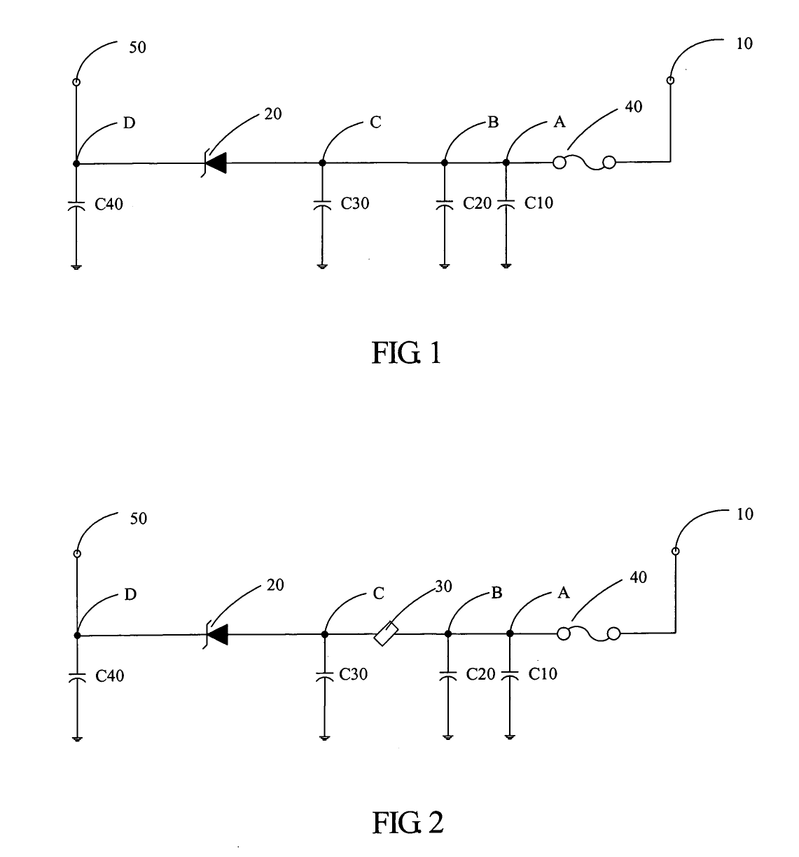

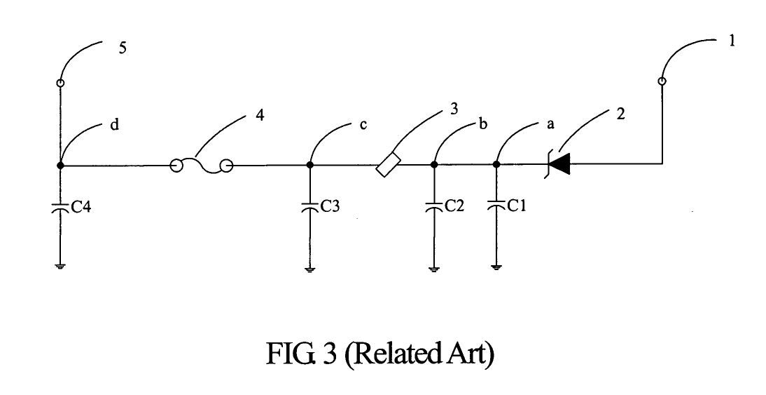

As shown in FIG. 1, in a preferred embodiment of the present invention, a power supply for a bus interface includes a diode 20, a fuse 40, a capacitor C10 used for filtering noise of an input terminal, a capacitor C20 used for filtering high frequency noise, a capacitor C30 used for filtering low frequency noise, and a high rated capacitor C40 used for filtering noise of an output terminal.

An input terminal 10 is connected to an anode of the diode 20 via the fuse 40. An output terminal 50 is connected to a cathode of the diode 20. Nodes A, B, C between the fuse 40 and the anode of the diode are grounded via the capacitors C10, C20, C30 respectively. A node D between the cathode of the diode 20 and the output terminal 50 is grounded via the high rated capacitor C40. A rated current of the fuse 40 is 1.5 A. A reverse breakdown voltage of the diode 20 is 40V. Rated voltage of the capacitors C10, C20, C30 are all 16V. A rated voltage of the high rated capacitor C40 is 50V. Alternately, the fuse 40 can be connected between the cathode of the diode 20 and the output terminal 50.

The input terminal 10 receives a 12V voltage. The 12V voltage is sent to equipment connected to the output terminal 50 via the power supply. When the current through the fuse 40 is over 1.5 A, the fuse 40 cuts off. Thus the power supply can provide over-current protection. When a voltage of the output terminal 50 is over 12V, the diode 20 is cutoff. Thus the power supply can provide over-voltage protection.

In the illustrated embodiment, if the voltage of the output terminal 50 is as high as 40V and a voltage of the input terminal 10 is as low as 0V in some transient state, that is, the reverse voltage of the diode 20 is 40V (40V-0V), the diode 20 will not break down because the reverse breakdown voltage of the diode 20 is 40V. Thus the power supply can provide effective over-voltage protection. Considering that an operational power of an element is about 70% of the rated power, the rated voltage of the high rated capacitor C40 is 50V because an operation voltage of the high rated capacitor C40 is not more than 40V. Furthermore, when the voltage of the cathode of the diode 20 reaches 12V, the diode 20 cuts off. Therefore, operational voltages of the capacitors C10, C20, C30 are not more than 12V. So the rated voltage of the capacitors C10, C20, C30 is 16V. Thus capacitors having a lower rated voltage are employed, ensuring that a cost of manufacturing the circuit will decrease.

As shown in FIG. 2, in another preferred embodiment of the present invention, the power supply further includes a magnetic bead 30 compared to the first preferred embodiment. The magnetic bead 30 is connected between the fuse 40 and the anode of the diode 20. The magnetic bead 30 is used as a filter.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A power supply for a bus interface, the power supply comprising:
an input terminal;
an output terminal;
a fuse providing over-current protection;
a diode providing over-voltage protection, a reverse breakdown voltage of the diode not less than a maximal voltage difference of the output terminal and the input terminal, the diode connected to the fuse in series between the input terminal and the output terminal; and
a plurality of capacitors filtering noise, one end of each of the capacitors connected to a node between the fuse and an anode of the diode, and another end of each of the capacitors grounded.

2. The power supply as claimed in claim 1, further comprising a magnetic bead used as a filter, the magnetic bead is connected between the fuse and the anode of the diode.

3. The power supply as claimed in claim 1, wherein a rated voltage of the diode is 40V.

4. The power supply as claimed in claim 1, wherein a rated current of the fuse is 1.5 A.

5. The power supply as claimed in claim 1, wherein the capacitors comprise a capacitor close to the input terminal used for filter noise of the input terminal.

6. The power supply as claimed in claim 1, wherein the capacitors comprise a capacitor used for filtering high frequency noise.

7. The power supply as claimed in claim 1, wherein the capacitors comprise a capacitor used for filtering low frequency noise.

8. The power supply as claimed in claim 1, wherein a voltage rating of each of the capacitors is 16V.

9. The power supply as claimed in claim 1, further comprising a capacitor with a high voltage rating used for filtering noise of the output terminal, one end of the high rated capacitor is connected to a cathode of the diode, and another end of the high rated capacitor is grounded.

10. The power supply as claimed in claim 9, wherein the high rated capacitor is rated at 40V.

11. A power supply for a bus interface, the power supply comprising:
an input terminal receiving a system voltage;
an output terminal providing an output voltage to a load;
a first element providing over-current protection;
a second element providing over-voltage protection, the second element connected to the first element in series between the input terminal and the output terminal; and
a plurality of capacitors filtering noise, one end of each of the capacitors connected to a node between the fuse and an anode of the diode, and another end of each of the capacitors grounded.

12. The power supply as claimed in claim 11, wherein the first element is a fuse.

13. The power supply as claimed in claim 11, wherein the second element is a diode, a reverse breakdown voltage of the diode not less than a maximal voltage difference of an output terminal and an input terminal, an anode of the diode is connected to the input terminal, a cathode of the diode is connected to the output terminal.

14. The power supply as claimed in claim 11, further comprises a magnetic bead used as a filter, wherein the magnetic bead is connected between the fuse and the anode of the diode.

15. The power supply as claimed in claim 11, further comprising a high rated capacitor with a high voltage rating used for filtering noise of the output terminal, wherein one end of the high rated capacitor is connected to a cathode of the diode, and anther end of the high rated capacitor is grounded.

16. A connective circuit for power supply to a bus interface, comprising:
an input terminal electrically connectable to a power source for receiving a system voltage therefrom;
an output terminal electrically connectable to a bus interface so as to provide an output voltage to a load via said bus interface;
a plurality of capacitors electrically connectable between said input terminal and said output terminal so as to accept said system voltage from said input terminal and provide said output voltage toward said output terminal in order for filtering noise induced in said system voltage and said output voltage; and
an over-voltage control element electrically connectable between said plurality of capacitors and said output terminal, and said element enabling over-voltage control throughout said plurality of capacitors to said input terminal.

17. The circuit as claimed in claim 16, wherein said element is a diode.

18. The circuit as claimed in claim 16, wherein said plurality of capacitors is arranged in a parallel connective relationship.

19. The circuit as claimed in claim 16, further comprises another over-current element electrically connectable with said over-voltage control element in series.

20. The circuit as claimed in claim 16, further comprises a magnetic bead for filtering electrically connectable with said plurality of capacitors in series.
